(19) United States
(12) Patent Application Publication
(10) Pub. No.: US 2020/0164577 A1
(43) Pub. Date: May 28, 2020

(54) BUILD MATERIAL-RETAINING WALL

(71) Applicant: Hewlett-Packard Development Company, L.P., Spring, TX (US)

(72) Inventors: Emiliano Tolosa, Sant Cugat del Valles (ES); Michael Crockett, Vancouver, WA (US); Brent Ewald, Vancouver, WA (US)

(21) Appl. No.: 16/633,883

(22) PCT Filed: Jul. 31, 2017
(86) PCT No.: PCT/US2017/044744

§ 371 Date: Jan. 24, 2020

(51) Int. Cl. B29C 64/218; B29C 64/245; B29C 64/227; B29C 64/255; B29C 64/25; B33Y 30/00; B33Y 10/00

(52) U.S. Cl. CPC B29C 64/218; B29C 64/245; B29C 64/227; B33Y 10/00; B29C 64/25; B33Y 30/00; B29C 64/255

(57) ABSTRACT

A technology is described herein that includes a printer or a device with a fix or removable build unit. The printer has a spreader to spread a build material on the build unit and particularly, on a build platform of the build unit. The build unit further includes: a build material-retaining wall that blocks excess build materials overshooting an edge of the build platform as the spreader spreads the build material; and a frame that is disposed between the build platform and the build material-retaining wall in order to provide a stopping area for the blocked excess material. The build unit also have a trigger mechanism to detect a triggering condition and a wall-retraction mechanism coupled to the build material-retaining wall. The wall-retraction mechanism retracts the build material-retaining wall in response to the detected triggering condition.

### BACKGROUND

Additive manufacturing, which is commonly referred to as three-dimension (3D) printing, enables the formation of 3D objects. For example, the formation of the 3D object may include selective solidification of a build material on a layer-by-layer basis.

Powder-based 3D printing systems, for example, typically form successive thin layers of a particulate build material and selectively solidify portions of each layer that represent a cross-section of the 3D object. Selective solidification techniques may include, for example, use of a printable fusing agent in combination with the application of fusing energy to cause portions of the build material on which fusing agent is printed to absorb more energy than portions of build material on which no fusing agent is printed. The portions on which the fusing agent is printed melt and solidify to form part of the 3D object being printed, whereas non-fused build material remains in a generally non-solidified state and may be removed and, in some cases, reused in the generation of further 3D objects.

### BRIEF DESCRIPTION OF THE DRAWINGS

FIG. 1 is an example block diagram of a 3D printer or device in accordance with an example of the technology described herein.

FIG. 2 illustrates an example build platform structure in accordance with an example of the technology described herein.

FIGS. 3A-3D illustrate example stages of a spreading process in accordance with an example of the technology described herein.

FIG. 4 illustrates an example alternative mode of retracting build material-retaining wall in accordance with an example of the technology described herein.

FIG. 5 is an example process chart illustrating an example method for spreading a build material in a build platform in accordance with an example of the technology described herein.

FIG. 6 illustrates an example 3D printer system in accordance with an example of the technology described herein.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

Described herein is a technology that includes a printer or a device with a fix or removable build unit structure. That is, the build unit structure may be integrated with the printer or device as one unit, or the build unit structure may be shipped separately from the printer or device.

The printer or device has a spreader to spread a pile of build material such as a powdered resin, plastic, ceramic, nylon, and the like, on the build unit structure and particularly, on a build platform of the build unit structure. The build unit structure further includes: a build material-retaining wall that blocks excess build materials overshooting an edge of the build platform as the spreader spreads the build material; and a frame that is disposed between the build platform and the build material-retaining wall in order to provide a stopping area for the blocked excess material. The frame, however, may be a component of the printer or device and in such a case, the shipping of the removable build structure may not include the frame.

The build unit structure further includes a trigger mechanism to detect a triggering condition such as a present position or location of the spreader on the build platform. In response to the detection of the triggering condition, the spreader changes speed and spreading-height elevation until the spreader may be vertically aligned with the build material-retaining wall. At this position, the spreader may perform a recoating or a re-spreading at an opposite direction by moving downward to its initial spreading-height and in sync with retraction of the build material-retaining wall. The spreader is further controlled to continue the re-spreading at the opposite direction, and the build material-retaining wall 206 may be configured to move up again in preparation for next spreading cycle

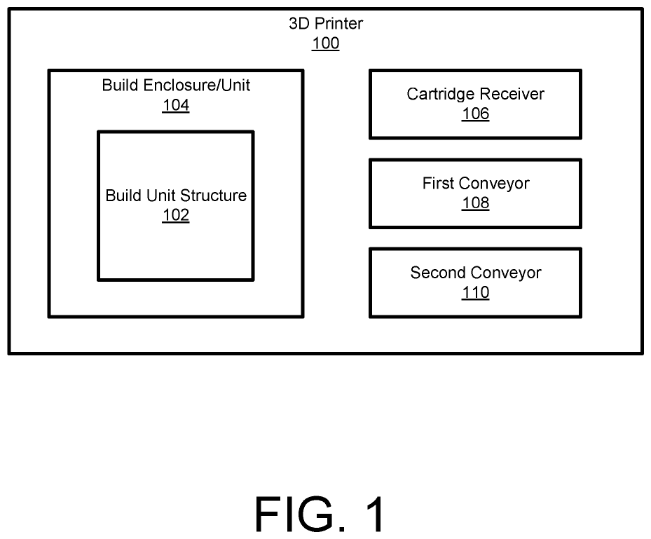

FIG. 1 is an example basic block diagram of a 3D printer or device in accordance with an example of the technology described herein. As shown, a 3D printer 100 may include a build unit structure 102 that may be disposed within a build enclosure, or build unit, 104; a cartridge receiver 106; a first conveyor 108 that may transport materials from the cartridge receiver 106 to the build unit structure 102; and a second conveyor 110 that may be used to recover excess or unused build material from the build unit 104.

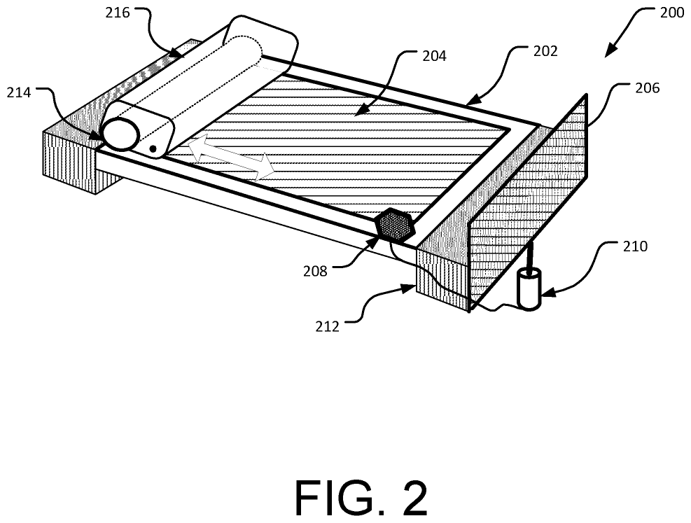

The build unit structure 102 may provide a system for starting a 3D printing of an object array or objects to be built. The build unit 104 may be removable as a separate unit from the 3D printer 100. The build unit structure 102 may also be a fix unit that is integrated to the printer itself. Furthermore, the build unit structure 102 may include components such as a build platform, a trigger mechanism, a build material-retaining wall, and the like, as further discussed in FIG. 2 below. These components may be mounted, either directly or indirectly, to an axis transport mechanism, which may be attached to a frame of the 3D printer. The axis transport mechanism, for example, may provide a mechanism for the components to traverse or maneuver above the build platform.

To print a particular object, the 3D printing may include processes such as, but are not limited to: virtual slicing a 3D model of the object into two-dimensional (2D) slices; depositing a pile of build material on the build platform; spreading the build material to form a build material-layer on the build platform; performing a selective solidification of the formed build material-layer; and optional curing of the bound build materials.

The cartridge receiver 106 may be disposed adjacent to the build unit 104 and may further include a canister that receives an excess or other non-solidified build materials from the build unit 104. The received excess build materials such as excess powder may be stored for future use or discarded.

For example, the first conveyor 108 may transport the excess powder, resin, plastic, or the like, from the cartridge receiver 106 to the build material-dispersing mechanism on the build unit structure 102. In this example, the second conveyor 110 may include a vacuum system with conduits or a manifold that facilitates recovery of the excess build material from the build unit structure 102.

FIG. 2 illustrates an example build unit structure 200 in accordance with an example of the technology described herein. The example build unit structure 200 may represent the build unit structure 102 in FIG. 1. As shown, the build unit structure 200 may include a build platform 202 with a printable area 204, a build material-retaining wall 206, a trigger mechanism 208, a wall-retraction mechanism 210, and a frame 212 that is disposed in between the build platform 202 and the build material-retaining wall 206. FIG. 1 further illustrates other components of the 3D printer or device such as a spreader 214 that may be integrated to a build material-dispersal mechanism 216. Although the frame 212 is shown to be a component of the build unit structure 200, the frame 212 may also be integrated to the 3D printer or device and not part of the build unit structure 200.

During a build material-deposition process such as a powder deposition process, the build material-dispersal mechanism 216 may initially deposit a pile of build materials such as powder at one side or edge of the build platform 202. Thereafter, the spreader 214 may traverse the build platform 202 and spread the pile of build materials from the one side or edge of the build platform 202, to opposite side or a recoating edge of the build platform 202 in order to form a substantially flat layer of build materials. The opposite side or the recoating edge of the build platform 202 refers to the side of the build platform 202 that adjoins the frame 212.

The spreader 214, for example, may be shaped like a roller that may apply a uniform pressure at a certain height on a surface of the build platform 202. In this example, the roller may be coupled to the axis transport mechanism that facilitates the movement of the roller during the spreading process. The movement of the roller towards the recoating edge of the build platform 202 may generate, for example, the inertial momentum that accumulates excess build materials. The excess build material may form a build material-mass or herein referred to as a build material-accumulation of a certain amount or volume at the edge of the build platform 202 and/or at a top surface of the frame 212, which provides a stopping area for the excess build material.

The frame 212 may be a platform that is separate from the build unit structure 200, or the frame 212 may be integrated to the build unit structure 200 and attached to the build platform 202 in order to provide structural support. The top surface of the frame 212, which is about 55 millimeters in width, may be coplanar with the edge of the build platform 202. The top surface of the frame 212 may include a flat surface that provides a substantial stopping area for the build material-accumulation during the spreading process.

In another example, the spreader 214 may be a flat bar. In this other example, the flat bar may be coupled to the axis transport mechanism that facilitates the flat bar to move in a linear direction towards the recoating edge of the build platform 202. The movement of the flat bar towards the recoating edge may generate the inertial momentum that pile up excess build material from the build platform 202. As a consequence, the build material-accumulation may be formed on the edge of the build platform 202 and/or the top surface of the frame 212.

In the examples above, the trigger mechanism 208 may be configured to detect a triggering condition that may be used as a basis for retracting the build material-retaining wall 206. The trigger mechanism 208 may be one or more of or some combination of mechanical sensor, an optical sensor, timer, and/or linear/rotary encoder that is used in conjunction with a controller. The triggering condition may include a distance traveled by the spreader 214, a present position or location of the spreader 214 on the build platform 202, or an amount or volume of the build material-accumulation.

For example, for a particular spreading of a pile of build material-layer, the inertial momentum generated by the spreader 214 may amass the excess build material at the edge of the build platform 202 and/or the top surface of the frame 212. In this example, the trigger mechanism 208 may include a sensor that detects the distance traveled by the spreader 214. Alternatively, the sensor may detect that the present location of the spreader 214 is at the edge of the build platform 202. In another case, the sensor of the trigger mechanism 208 above may be a switch component that detects whether the position of the spreader 214 is aligned with the trigger mechanism 208, which may be disposed at the edge of the build platform 202. In response to each of these detections, the trigger mechanism 208 may send a control signal to retract the build material-retaining wall 206.

The build material-retaining wall 206 may be made of a flexible and thermally resistant stable material such as a silicon material. The build material-retaining wall 206 may be disposed adjacent to the edge of the frame 212 in order to block the excess build material from the build platform 202 during the spreading process. For example, the build material-retaining wall 206 may include a planar side-surface that envelopes a length of the edge of the frame 212. In this example, the planar side-surface of the build material-retaining wall 206 may form a right angle with the top surface of the frame 212. In another example, the build material-retaining wall 206 may include extended flanges or channels that partially wrap corner edges of the frame 212. The extended flanges or channels may block the momentum of the build material at the corner edges of the frame 212 such that the build material-accumulation may be concentrated at the top surface of the frame 212.

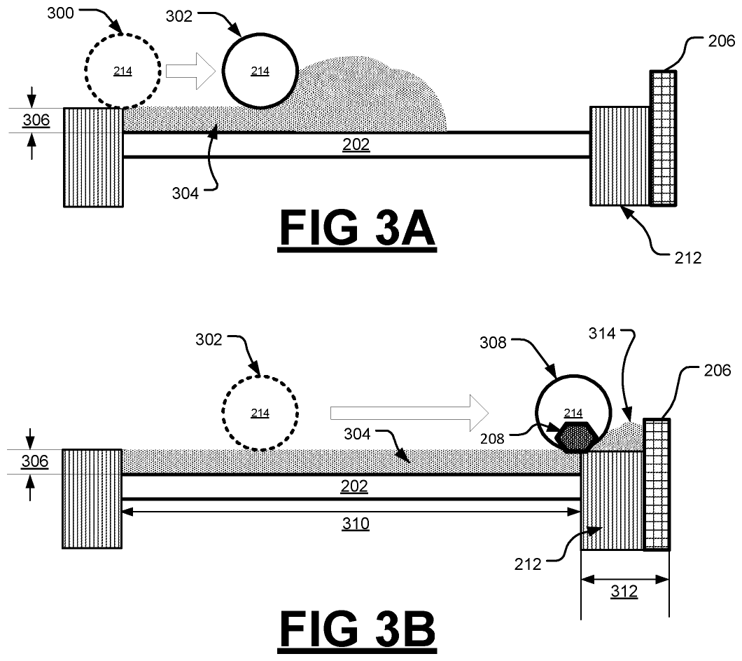

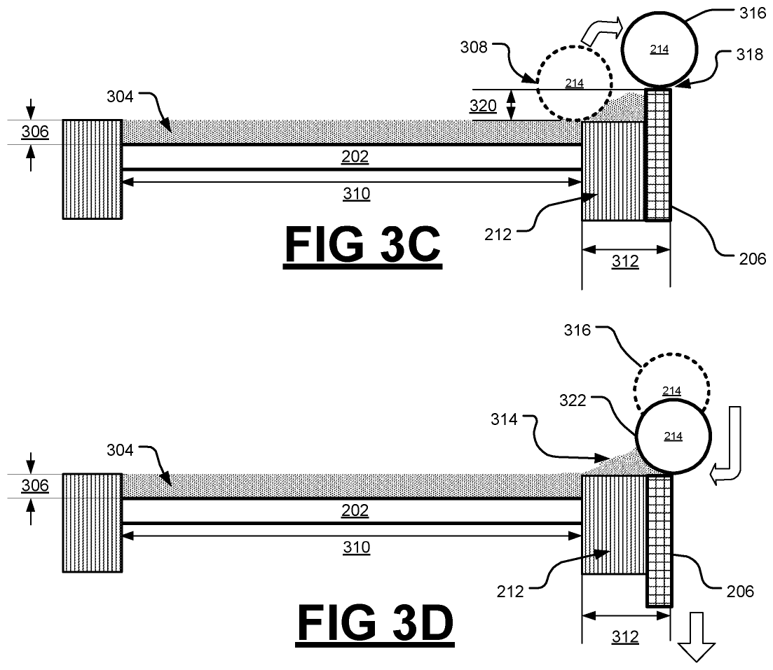

The build material-retaining wall 206 may be coupled to the wall-retraction mechanism 210 that is configured to retract the build material-retaining wall 206 in response to the detected triggering condition. For example, upon detection by the detection mechanism 212 that the spreader 214 is located at the edge of the build platform 202, the detection mechanism 212 may send a signal through a wired or wireless connection to the wall-retraction mechanism 210 in order to retract the build material-retaining wall 206. In this example, the spreader 214 may be configured to decelerate and change spreading-height until the spreader 214 may be vertically aligned with the build material-retaining wall 206 as further discussed in FIG. 3 below.

Thereafter, the spreader 214 moves downward and in synchronization with the retraction of the build material-retaining wall 206. Upon reaching its initial spreading-height, the spreader 214 may continue the re-spreading at the opposite direction towards the other end of the build platform 202.

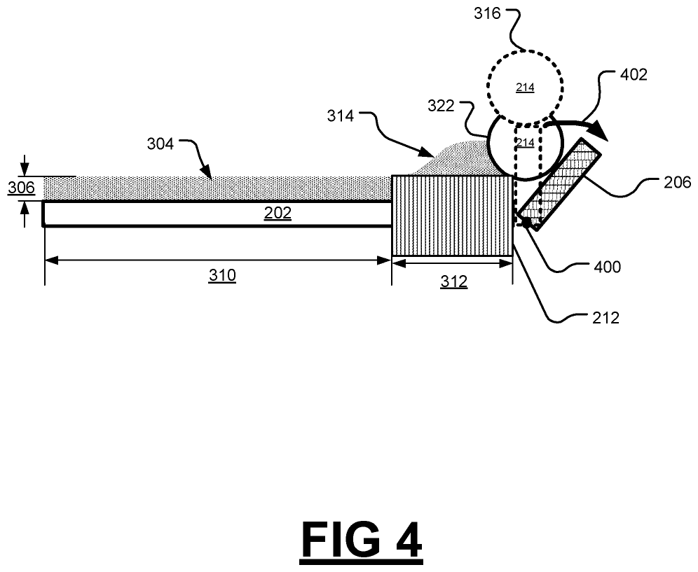

As described herein, the wall-retraction mechanism 210 may include a solenoid for a vertical retraction of the build material-retaining wall 206, or an axis of rotation for a backward retraction of the build material-retaining wall 206 as further discussed in FIG. 4 below.

FIGS. 3A-3D illustrate example stages of a spreading process in accordance with an example of the technology described herein.

FIG. 3A shows the spreader 214 that traverses the build platform 202 from an initial first location 300 to a second location 302 during an example initial stage of the spreading process. For example, the build material deposition process—through the build material-dispersal mechanism 216—may form an initial pile of build material on one side of the build platform 202. With the deposited pile of build material, the spreader 214 flattens the pile of build material to form a build material-layer 304. The build material-layer 304 may include a uniform density and a uniform build material-height 306, which is about 3-4 millimeters.

As the spreader 214 traverses the build platform 202 towards the direction of the build material-retaining wall 206, the spreader 214 generates an inertial momentum that may accumulate excess build materials from the build platform 202. The accumulation of the build material accumulation may be due to blocking effect of the build material-retaining wall 206 that is disposed adjacent to the edge of the frame 212.

FIG. 3B shows an example spreading process stage where the spreader 214 is moving from its previous second location 302 to a third location 308. FIG. 3B further shows the build material-layer 304, a first distance 310, a second distance 312, and a build material-accumulation 314. The example third location 308 is shown to be at a point in between the edge of the build platform 202 and the frame 212. That is, in between first distance 310 and the second distance 312. The first distance 310 and the second distance 312 may define the length of the build platform 202 and the width of the frame 212, respectively.

As described herein, the spreader 214 may be configured to traverse the first distance 310 of the build platform 202 at a certain velocity. Upon reaching the end of the first distance 310, the spreader 214 may be configured to have a speed-deceleration and a simultaneous elevation in spreading-height as further discussed in FIG. 3C below.

Due to the excess build materials that may pass over the edge of the build platform 202 during the spreading process, the build material-accumulation 314 may be formed at the edge of the build platform 202 and/or the top surface of the frame 212. The piled-up build material-accumulation 314 may include excess build material after the formation of the build material-layer 304 on the build platform 202. Furthermore, the build material-accumulation 314 may be concentrated on the flat top surface of the frame 212, which provides the stopping area for the blocked excess build material.

Referencing the trigger mechanism 208 that is configured to detect the triggering conditions for the retraction of the build material-retaining wall 206, the trigger mechanism 208 may detect, for example, that the spreader 214 has traveled the first distance 310. The detection may include a comparison of the detected distance traveled by the spreader 214 to a pre-defined threshold, or the detection may include determination of the spreader 214 to be in alignment with the trigger mechanism 208, which is disposed at one end of the first distance 310. In response to this detection, the spreader 214 may change speed and spreading-height elevation.

In another example, the spreader 214 may be pre-configured to travel the first distance 310 at a certain velocity and at spreading-height 304. When the spreader 214 reaches the end of the first distance 310, the spreader 214 may be pre-configured to decelerate in speed and change spreading-height as the spreader travels the second distance 312. The deceleration and changes in the spreading-height may be maintained until the end of the second distance 312 where the spreader 214 begins to travel to perform the re-spreading process at the opposite direction.

FIG. 3C shows an example spreading process stage where the spreader 214 is moving from its previous third location 308 to an elevated fourth location 316 where the spreader 214 is vertically aligned with the build material-retaining wall 206. FIG. 3C further shows a delayed retraction of the build material-retaining wall 206 in order to prevent the build material-accumulation 314 from dispersing through a gap 318 that is located in between the spreader 214 and the build material-retaining wall 206. Furthermore still, FIG. 3C shows an additional spreading-height 320 that shows elevation difference between the fourth location 316 and the third location 308.

In response to the detection of the triggering conditions as discussed above, the spreader 214 may be configured to change speed and spreading-height at the end of the first distance 310. For example, the spreader 214 maintains a particular constant speed at the spreading-height 306 for the duration of the first distance 310. At the end of the first distance 310, the spreader changes spreading—height and hops over the top surface of the frame 212 which is the stopping area for the excess build materials.

At the fourth location 316, the spreader 214 begins the re-spreading or the recoating process in the opposite direction by moving downward to its initial spreading-height 306 and in synchronization with the retraction of the build material-retaining wall 206. The synchronization between the downward movement of the spreader 214 and the retraction of the build material-retaining wall 206 may avoid the build material-accumulation 314 from traveling through the gap 318, which is located in between a top surface of the build material-retaining wall 206 and a bottom surface of the spreader 214. At the spreading-height 306, the spreader 214 may begin to re-spread at the opposite direction towards the other end of the build platform 202.

As described herein, the top surface of the build material-retaining wall 206 may include, for example, a thermally flexible material that slightly contacts the bottom surface of the spreader 214 during the synchronized downward movements of the spreader 214 and the build material-accumulation 314. For example, the gap 318 may be avoided by the slight contact and build material-accumulation 314 may still be supported by the build material-retaining wall 206 as the spreading process continues in the opposite direction.

FIG. 3D shows an example spreading process stage where the spreader 214 is moving from its previous elevated fourth location 316 to a fifth location 322, which illustrates the spreader 214 returning at the spreading-height 306 and beginning to traverse the build platform 202 in the opposite direction.

As described herein, when the spreader 214 reaches the end of the second distance 312 and is in vertical alignment with the build material-retaining wall 206, the spreader 214 moves downward in synchronization with the retraction of the build material-retaining wall 206. The spreader 214 goes back to its initial spreading-height 306 at the fifth location 322, and performs the re-spreading of the build material at the opposite direction towards the other end of the build platform 202. As soon as the spreader 214 leaves the edge of the frame 212 in the opposite direction, the build material-retaining wall 206 may be configured to move up again to its original position in preparation for a next spreading cycle.

FIG. 4 illustrates an example alternative mode of retracting the build material-retaining wall in accordance with an example of the technology described herein. As shown, the build material-retaining wall 206 includes an axis of rotation 400 that may facilitate a backward retraction of the build material-retaining wall 206 in a direction illustrated by a direction 402.

Similar to FIG. 3D above, FIG. 4 shows the example spreading process stage where the spreader 214 is moving from its previous elevated fourth location 316 to the fifth location 322, which illustrates the spreader 214 returning at the spreading-height 306 and beginning to traverse the build platform 202 in the opposite direction.

As described herein, the spreader 214 moves downward from the fourth location 316 and in synchronization with the backward retraction of the build material-retaining wall 206. For example, the backward retraction towards the direction as illustrated by the direction 402 may include a movement of about 45 degrees from an initial vertical position of the build material-retaining wall 206. In this example, the build material-retaining wall 206 rotates around the axis of rotation 400 and in synchronization with the downward movement of the spreader 214.

The spreader 214 goes back to its initial spreading-height 306 and performs flattening of the build material-layer 304 at the opposite direction towards the other end of the build platform 202. As soon as the spreader 214 leaves the edge of the frame 212 in the opposite direction, the build material-retaining wall 206 may be configured to move up again to its original vertical position in preparation for a next spreading cycle.

In order to minimize effects of a possible contact between the top surface of the build material-retaining wall 206 and the bottom surface of the spreader 214, an upper portion or at least the top surface of the build material-retaining wall 206 may be made of thermally resistant and flexible silicone materials while the main body may be made of aluminum materials. For example, when the spreader 214 reaches the fourth location 316, the thermally flexible silicone material of the upper portion may contact the bottom surface of the spreader 214 without affecting movements and operations of the spreader 214. Furthermore, the thermally flexible—upper portion may provide blocking of the build material-accumulation 214 by minimizing spaces on the gap 318.

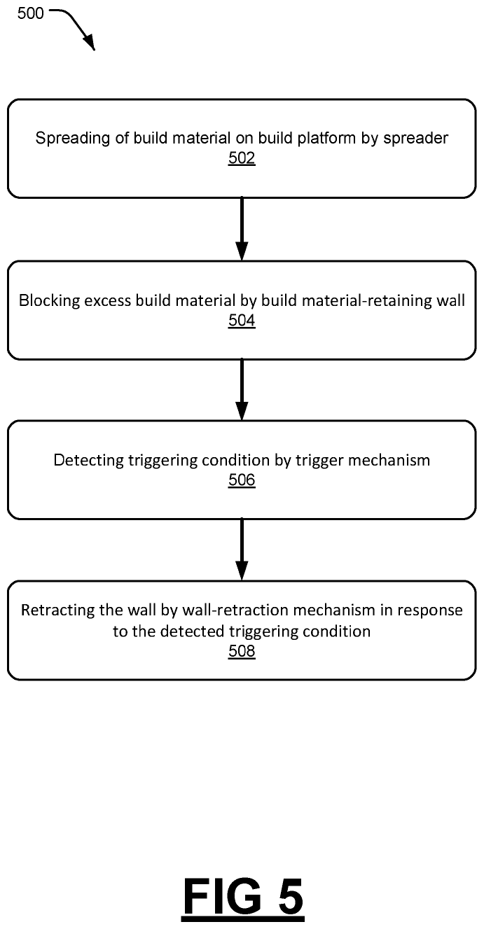

FIG. 5 shows an example process chart 500 illustrating an example method for spreading build material in a build platform in accordance with an example of the technology described herein.

At block 502, spreading of build material on a build platform is performed. For example, the build material-dispersal mechanism 216 performs a build material deposition to form the pile of build materials at one side of the build platform 202. In this example, the spreader 214 may be configured to spread or flatten the pile of build materials to form the build material-layer 304, which includes a certain height such as the build material-height 306.

At block 504, blocking excess build material by a build material-retaining wall is performed. For example, after the formation of the build material-layer 304 on the build platform 202, excess build materials may flow over the edge of the build platform and stops at the top surface of the frame 212, which is disposed in between the build platform 202 and the build material-retaining wall 206. The top surface of the frame 212 may include a flat surface that provides a stopping area for the excess build materials from the build platform 202. In this example, the build material-retaining wall 206 is disposed adjacent to an edge of the frame 212 and blocks the excess build material to form the build material-accumulation 214 on the top surface of the frame 212.

At block 506, detecting a triggering condition by a trigger mechanism is performed. For example, the trigger mechanism 208 may be disposed at the edge of the build platform 202. The trigger mechanism 208 may include a sensor that detects the distance traveled by the spreader 214 on the build platform 202. In another example, the sensor may detect the present location of the spreader 214 to be at the edge of the build platform 202. In another example still, the sensor of the trigger mechanism 208 above may be a switch component that detects whether the position of the spreader 214 is aligned with the trigger mechanism 208, which may be disposed in between the first distance 310 and the second distance 312. The first distance 310 and the second distance 312 may define the lengths of the build platform 202 and the frame 212, respectively.

At block 508, retracting the build material-retaining wall by a wall-retraction mechanism in response to the detected triggering condition is performed. For example, upon the detection of the triggering condition as discussed above, the spreader 214 may be controlled change speed and spreading-height elevation until the spreader 214 is in vertical alignment with the build material-retaining wall 206. In this example, the spreader 214 begins to perform the re-spreading at the opposite direction by moving downward to its initial spreading-height and in synchronization with the retraction of the build material-retaining wall 206.

As the spreader 214 performs the re-spreading at the opposite direction and at the spreading-height 306, the build material-retaining wall 206 may be configured to move up again in preparation for next spreading cycle.

Note that the order in which the processes are described is not intended to be construed as a limitation, and any number of the described process blocks can be combined in any order to implement the processes or an alternate process. Additionally, individual blocks may be deleted from the processes without departing from the spirit and scope of the subject matter described herein.

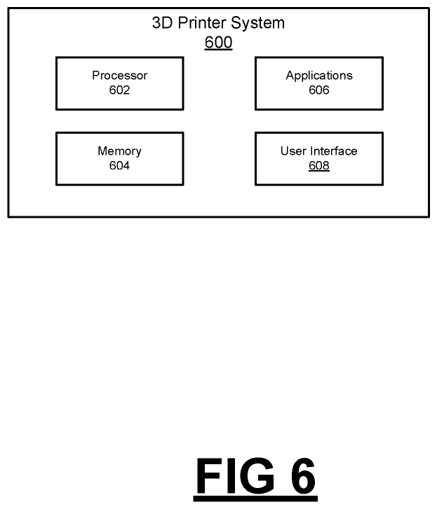

FIG. 6 shows an example 3D printer system 600 in accordance with an example of the technology described herein. The 3D printer system 600 may include a processor 602, a memory 604, applications 606, and user interface 608.

As described herein, the processor 602 may execute a program from the application 606 in order to perform the methods as discussed in FIG. 5 above. Particularly, the program may control operations of the build material deposition, change of speed and spreading-height by the spreader 214, etc. The processor 602 may further receive input instructions through the user interface 608.

The memory 604 may include a non-volatile storage such as, but not limited to, a magnetic disk drive, optical disk drive, tape drive, an internal storage device, an attached storage device, flash memory, battery backed-up SDRAM (synchronous DRAM), and/or a network accessible storage device. The memory 604, for example, may store virtual slice representations of the object to be printed.

What is claimed is:

1. A printer comprising:
a spreader; and
a build unit that comprises:
a build platform that holds a pile of build material, wherein the spreader spread the pile of build material on the build platform;
a build material-retaining wall to block excess build material spread by the spreader from the build platform;
a frame disposed in between the build platform and the build material-retaining wall, the frame to provide a stopping area for the blocked excess build material;
a trigger mechanism to detect a triggering condition;
a wall-retraction mechanism coupled to the build material-retaining wall, the wall-retraction mechanism to retract the build material-retaining wall in response to the detected triggering condition.

2. The printer as recited in claim 1 further comprising a controller to control a change in speed and spreading-elevation of the spreader in response to the detected triggering condition.

3. The printer as recited in claim 1 further comprising a controller to control a hopping of the spreader over a top surface of the frame, the hopping is maintained until the spreader is in vertical alignment with the build material-retaining wall.

4. The printer as recited in claim 1 further comprising a controller to control a downward movement of the spreader during a re-spreading process in an opposite direction, the downward movement of the spreader is in sync with the retraction of the build material-retaining wall.

5. The printer as recited in claim 1, wherein the trigger mechanism is disposed at an edge of the build platform.

6. The printer as recited in claim 1, wherein the triggering condition comprises a location-detection of the spreader on the build platform.

7. The printer as recited in claim 1, wherein the build material-retaining wall includes a thermally resistant and flexible material.

8. A device comprising:
a spreader;
a frame; and
a removable build unit that comprises:
a build platform that holds a pile of build material, wherein the spreader spread the pile of build material on the build platform;
a build material-retaining wall to block excess build material spread by the spreader from the build platform, wherein a top surface of the frame provides a stopping area for the blocked excess build material;
a trigger mechanism to detect a triggering condition;
a wall-retraction mechanism coupled to the build material-retaining wall, the wall-retraction mechanism to retract the build material-retaining wall in response to the detected triggering condition.

9. The device as recited in claim 8 further comprising a controller to control a change of spreading-height of the spreader in response to the detected triggering condition, the spreader maintaining the elevated spreading-height until the spreader is in vertical alignment with the build material-retaining wall.

10. The device as recited in claim 8, wherein the triggering condition includes a location-detection of the spreader on the build platform.

11. The device as recited in claim 8, wherein the trigger mechanism is a switch.

12. A method comprising:
spreading of build material on a build platform by a spreader;
blocking excess build materials spread by the spreader from the build platform by a build material-retaining wall;
detecting a triggering condition by a trigger mechanism;
retracting the build material-retaining wall by a wall-retraction mechanism in response to the detected triggering condition.

13. The method as recited in claim 12, wherein the spreading of the build material includes a change in speed by the spreader in response to the detected triggering condition, the change in speed is maintained until the spreader is in vertical alignment with build material-retaining wall.

14. The method as recited in claim 12, wherein the retracting of the build material-retaining wall is synchronized with a downward movement of the spreader during a re-spreading process.

15. The method as recited in claim 12, wherein the detecting the triggering condition includes a location-detection of the spreader on the build platform.
